(19) United States
(12) Patent Application Publication
(10) Pub. No.: US 2026/0111236 A1
(43) Pub. Date: Apr. 23, 2026

(54) FRAMEWORK FOR REUSABLE DATA MODEL EXPRESSIONS

(71) Applicant: SAP SE, Walldorf (DE)

(72) Inventors: Fabian FELLHAUER, Ostringen (DE); Boyan BOYCHEV, Karlsruhe (DE); Felipe Velloso ALVES, Rauenberg (DE); Timm FALTER, Sinsheim-Hilsbach (DE); Kolja GROSS, Karlsruhe (DE); Matthias HERCHENROETHER, Heidelberg (DE); Fee GRAUF, Spechbach (DE); Katharina ALTRICHTER, Heidelberg (DE); Santiago Zuniga GARCIA, Mannheim (DE)

(21) Appl. No.: 18/924,408

(22) Filed: Oct. 23, 2024

(51) Int. Cl. G06F 9/44

(52) U.S. Cl. CPC G06F 9/44

(57) ABSTRACT

According to some embodiments, systems and methods are provided including a memory storing program code; and one or more processing units to execute the program code to cause the system to: receive an aspect definition in a first format, the aspect definition including at least one aspect field; transform the aspect definition into aspect definition metadata, the aspect definition metadata is in a second format; store the aspect definition metadata; receive a view definition including a binding of the aspect definition and at least one view field; transform the view definition into view definition metadata, the view definition metadata is in the second format; and include the aspect definition metadata into a view, wherein activation of a view including an aspect links at the least one aspect field of the aspect definition to a corresponding at least one view attribute of the view definition. Numerous other aspects are provided.

### BACKGROUND

Often, applications are based on data models. A data model refers to the way data is organized, documented and defined within a database, and provides a framework of relationships between elements within the database, as well as a guide for use of the data. Data models provide a standardized method for defining and formatting database contents consistently across systems, enabling different applications to share the same data. A data model definition also describes the elements used by the model, such as entity types, attributes, relationships and data access strategies for entities, like third-party partners, sales orders, invoices, etc.

There are many services and tools that can be used to create data models. A non-exhaustive example of a data modeling service is Core Data Services (CDS)® from SAP, which allows for defining and consuming semantically rich data models on the central database of an application server. With respect to the data model definition, a CDS entity, for example, is defined as a set of elements that are organized using columns and rows. Elements describe the entity that they are associated with. Annotations are used to semantically enrich the CDS entity or its elements with additional information. In CDS, an expression may be used in a variety of ways including, but not limited to: path expressions, field list expressions, case expressions, calculated quantities, arithmetic expressions, and association-like calculated elements. With respect to the calculated quantities and arithmetic expressions, the expression may consist of one or more operands in combination with operators or specialized words that may be used to return a result in a data model.

A data model may be based on one or more entities. However, conventionally, reusing expressions like calculations or annotated semantics is only available for data models created for a same entity. To that end, for an expression to be reused, the expression is duplicated in the data model. As a non-exhaustive example, consider a data model that references both a sales order entity and a purchase order entity. It may be desirable to include a discount calculation expression in the data model for both the sales order and a purchase order (e.g., with a sales order entity and a purchase order entity). Conventionally, the discount calculation expression is duplicated within the model with respect to the sales order entity and the purchase order entity. Duplication may lead to inconsistencies if the duplication is not 100% identical. For example, errors may be introduced in copying the expression in multiple places in the data model (or in different models). The use of duplications also means that any changes to one of those duplicated expressions needs to be changed independently in each instance of the duplicated expression, which is time consuming and error-prone, leading to high development costs.

Systems and methods are desired to make it easier to reuse expressions in a data model.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a block diagram of an architecture according to some embodiments.

FIG. 2A is a flow diagram of an aspect activation process according to some embodiments.

FIG. 2B is a flow diagram of a view activation process according to some embodiments.

FIG. 2C is a flow diagram of an updated aspect activation process according to some embodiments.

FIG. 3 is a User Interface (UI) display of a non-exhaustive example of an aspect definition according to some embodiments.

FIG. 4 is a UI display of a non-exhaustive example of a view definition according to some embodiments.

FIG. 5 is a UI display of a non-exhaustive example of another view definition according to some embodiments.

FIG. 6 is a block sequence chart according to some embodiments.

FIG. 7 is a non-exhaustive example of a UI display of an executed view according to some embodiments.

FIG. 8 is a block diagram of a cloud-based architecture according to some embodiments.

Throughout the drawings and the detailed description, unless otherwise described, the same drawing reference numerals will be understood to refer to the same elements, features and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown but is to be accorded the widest scope consistent with the principles and features disclosed herein. It should be appreciated that in development of any such actual implementation, as in any engineering or design project, numerous implementation-specific decisions must be made to achieve the developer's specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

One or more embodiments or elements thereof can be implemented in the form of a computer program product including a non-transitory computer readable storage medium with computer usable program code for performing the method steps indicated herein. Furthermore, one or more embodiments or elements thereof can be implemented in the form of a system (or apparatus) including a memory, and at least one processor that is coupled to the memory and operative to perform exemplary method steps. Yet further, in another aspect, one or more embodiments or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

As described above, CDS is a tool used to create data models. CDS may be used to define data models in Structured Query Language (SQL)-oriented database systems. CDS includes Data Definition Language (DDL), Query Language/Open SQL, and Data Control Language (DCL). DDL contains annotations to enrich data models with domain-specific metadata; associations to replace joins with simple path expressions in queries; and expressions for calculations and queries. The query language/open SQL provides for consumption of CDS entities in Advanced Business Application Programming (ABAP) programs via Open SQL and other programs. DCL regulates the authorizations for CDS entities by providing modeled and declarative definitions of authorizations for CDS entities.

A difference between CDS and other data modeling approaches is that with CDS, intensive computations are pushed into the database by using complex CDS views and functions. The push into the database may result in decreased execution time compared to non-CDS data modeling, as much less data is transferred back and forth between the application and database layer. The use of CDS data modeling may also result in simplified application coding.

Direct access to underlying tables of a database may be made possible through the CDS views, which are virtual data models. A view is an entity that is not persistent; it is defined as the projection of other entities. The view may be created as a design-time file and stored in a repository. Key features of the CDS views include the ability to define views that access data from multiple tables, the use of annotations to provide additional information/metadata about the data model (e.g., data types, field labels, descriptions), and the ability to define associations between two or more entities in the data model (CDS view). The creation of CDS views involves defining the data model, which includes defining entities, fields, associations and annotations.

Defining entities are the building blocks of CDS views, which define the structure and elements of a table or view. They represent a logical data structure that can be used as a data source for further modeling. Views, on the other hand, are used to define a subset of data from one or more defining entities. Views are created by defining a SELECT statement on one or more entities. The SELECT statement is used to filter, group and aggregate data. Annotations are metadata that provide additional information about the elements of the CDS view, such as fields, entities or the view itself. Annotations may be used to describe the semantics of the elements/fields, define constraints, specify default values or provide documentation.

With SQL-oriented database systems, data models may be stacked vertically or associated horizontally. With vertical stacking, each layer of the stack represents a specialized version of the underlying entity, such that the granularity of each view (model) can be adjusted. With horizontal associations, the views are joined or associated horizontally to build up relationships to other entities. Conventionally, if you wanted to re-use expressions (e.g., calculations, annotations, etc.) across different views, it was only possible for the same entity and by including the expression somewhere very low in the stack and then duplicating it across the different views. In addition to expression duplication being tedious, error-prone, inconsistent and costly, re-using expressions within the stack also negatively impacts performance. Conventionally, the re-used expressions are introduced in a common view that is very low in the view stack so that everything that's on top of this view can access this lower-placed expression (e.g., in the stack, everything that's on top can see what's below). This low placement is detrimental to performance of the stack overall because of these additional layers formed on top of the common view. In particular, this expression that's low in the stack gets automatically processed in the views on top of this expression, even if the expression is not needed (e.g., the low expression is now part of the model even if it is not needed). For example, a top view may have a lot of objects that reference a single object in a low view including multiple objects. As such, when a top view is processed, it will have to process all of the objects on the bottom, resulting in the use of more processing resources than necessary. As a non-exhaustive example, consider a model for an entity including a discount calculation. The model including the calculation is placed on a bottom level because other models need this calculation. A user wants to create a new model of the entity related to shipping that does not need the discount calculation. However, if the shipping model is created on top of the discount model, the discount expression is included in the shipping model unnecessarily.

To address these problems, a reusable data model expression framework or system provided by one or more embodiments provides for the use of a reusable expression that may be included specifically where it is needed (e.g., on top; in a targeted location) without having to propagate the expression across the entire model. Herein, the reusable expression may be referred to as a re-use artifact or CDS aspect. The CDS aspect, as described herein, is a new object type for defining reusable expressions (e.g., fields, measures, annotations, etc.) in a loosely coupled artifact. The CDS aspect may be used as a shortcut to add keys to an entity definition. The CDS aspect provided by one or more embodiments performs metadata checks to ensure data consistency. The CDS aspect, described by embodiments, is not deployed on the database itself, but instead is persisted in a data model metadata repository of a server. Pursuant to embodiments, the CDS aspect is bound to a CDS entity by linking relevant elements. At compile time, embodiments resolve and replicate definitions of the CDS aspect in the CDS entity to get a consistent, executable data model. The CDS aspect described by embodiments may also include contract rules for lifecycle handling (e.g., rules that govern changes to the CDS aspect such that the CDS aspect is not changed in a way to break a consuming system).

It is noted that a conventional SAP Cloud Application Programming Model (CAP) may use a CDS aspect, but these conventional CDS aspects are only used with elements on a structural level, and there are no calculations performed on linked elements to the entity. The CDS aspect of the embodiments described herein, on the other hand, includes additional syntax elements; links CDS aspects to CDS entities on an instance level per the elements defined by annotations; and provides for multiple bindings of the same CDS aspect to address multiple use cases within the same entity.

A benefit provided by embodiments, is the provision of a single source of truth. The CDS aspect is defined once in the area of expertise, and may be reused across different entities. For example, different lines of business may use the same definition in their data models. Further, a consistent definition is provided across the company. Another benefit provided by embodiments is that the CDS aspect may be exchanged between different stacks, improving the interoperability of the models. Still another benefit provided by embodiments is a decrease in the total cost of development as CDS aspects may easily be included in models for different CDS entities. Additionally, the CDS aspect works out-of-the-box, without a user knowing the detail implementation, making deployment easier.

The CDS aspect provided by one or more embodiments further supports the following use cases: reusable measures (e.g., simple (restricted/calculated) measures and measure structures), nested CDS aspects (e.g., specialized measures), and modeling of new applications (e.g., integration of applications via supporting “one domain model”).

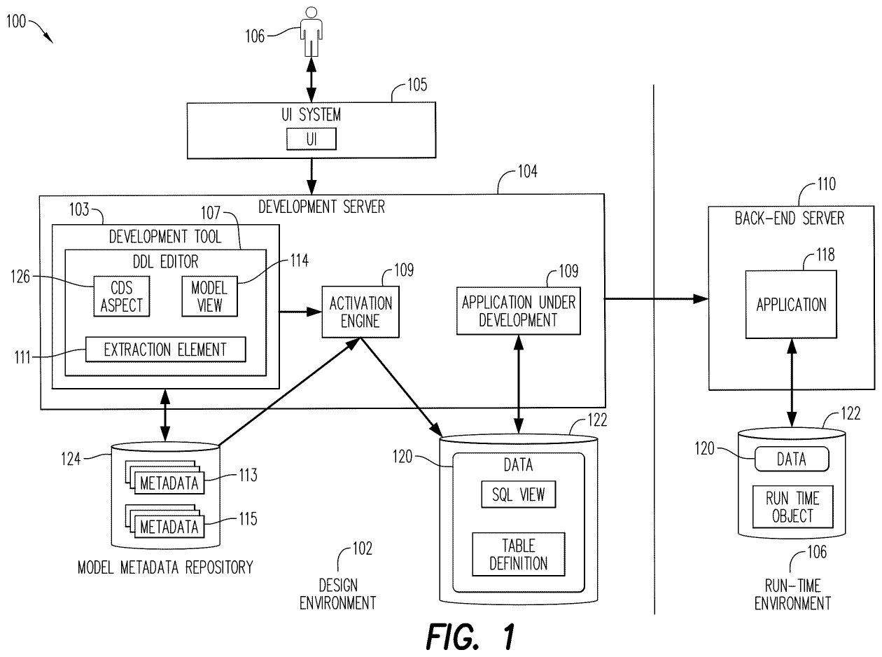

FIG. 1 is a high-level block diagram of a reusable expression framework or system architecture 100 according to some embodiments. The illustrated elements of system architecture 100 and of all other architectures depicted herein may be implemented using any suitable combination of computing hardware and/or software that is or becomes known. Such combinations may include one or more programmable processors (microprocessors, central processing units, microprocessor cores, execution threads), one or more non-transitory electronic storage media, and processor-executable program code. In some embodiments, two or more elements of system architecture 100 are implemented by a single computing device, and/or two or more elements of system architecture 100 are co-located. One or more elements of system architecture 100 may be implemented using cloud-based resources, and/or other systems which apportion computing resources elastically according to demand, need, price, and/or any other metric. One or more components may be implemented as a cloud service (e.g., Software-as-a-Service, Platform-as-a-Service).

System architecture includes a design-time environment 102 (including a development server 104 and user interface system 105) and a run-time environment 108 (including a back-end server 110).

The development server 104 and back-end server 110 may comprise one or more servers, virtual machines, clusters of a container orchestration system, etc. The development server 104 and back-end server 110 may provide an operating system, services, I/O, storage, libraries, frameworks, etc. to applications and other components executing therein.

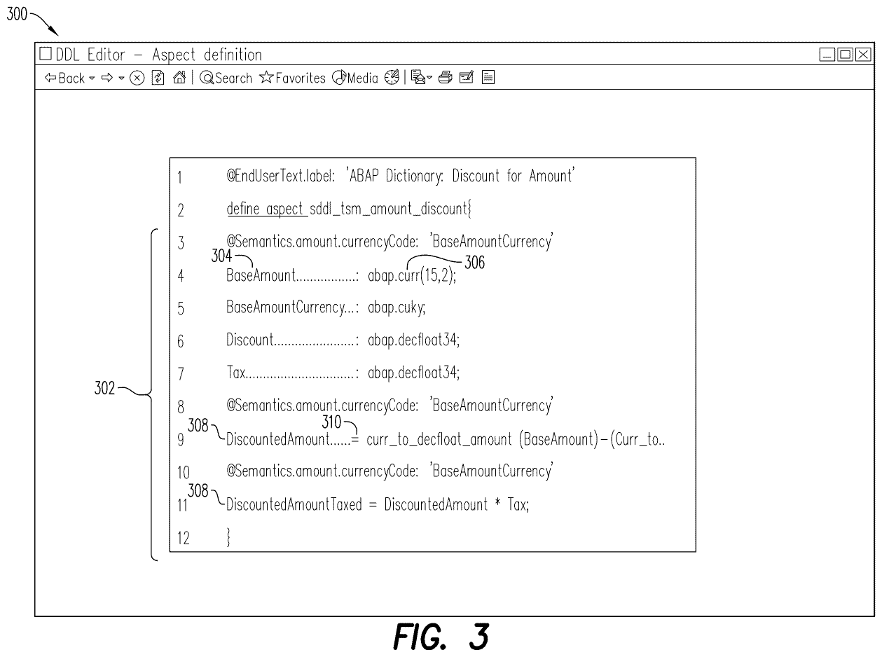

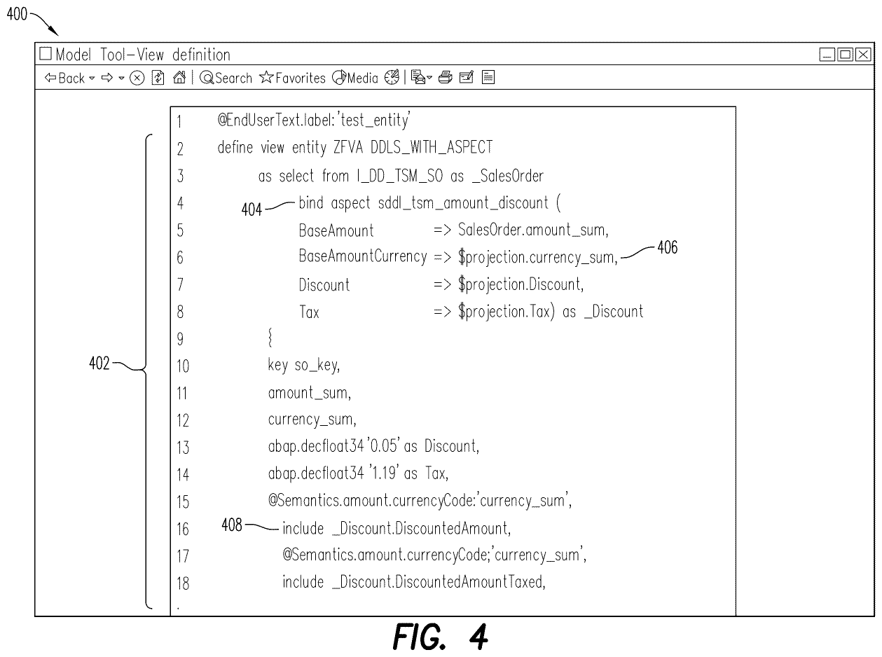

The design environment 102 hosts the creation of a CDS aspect 126 (“aspect”) and a data model/view 114 via execution of a development tool 103. The development tool 103 includes a Data Definition Language (DDL) editor 107 for receiving input code from a user 106 defining the aspect 126 and model/view. For example, the user 106 may input an aspect definition 302 (FIG. 3) into a user interface of the UI system 105 provided for the DDL editor 107. The user 106 may also input a view definition 402 (FIG. 4) into another user interface of the UI system 105 provided for the DDL editor 107.

As further described below, the data model 114 may be included in an application under development 116 being created on the development server 104. It is noted that while reference is made to creation of the aspect and the data model, the development server 104 may also host development of other suitable elements.

The UI system 105 may provide any suitable interfaces through which users 106 may communicate with the development tool 103 or applications executing thereon. The development server 104 and the backend server 110 may include a Hyper Text Transfer Protocol (HTTP) interface supporting a transient request/response protocol over Transmission Control Protocol/Internet Protocol (TCP/IP), a WebSocket interface supporting non-transient full-duplex communications which implement the WebSocket protocol over a single TCP/IP connection, and/or an Open Data Protocol (OData) interface.

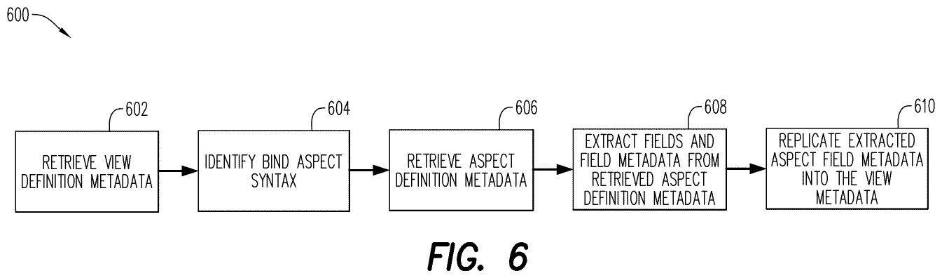

The design environment 102 also includes the model metadata repository 124. Pursuant to embodiments, each of the aspect and the view are created/saved at the DDL editor 107, via input to the user interface of the UI system 105, in a respective DDL file. It is noted that the DDL file may be in a DDL format or a DDL-derivative format. The DDL file is a plain text file that contains statements/commands for working with database structures such as tables, columns, records and other fields. The DDL editor 107 generates metadata 113/115 from each DDL file (e.g., for each aspect definition 302 and the view definition 402). The metadata 113/115 is a representation of the respective aspect as defined in the DDL file (“aspect definition”) and view as defined in the DDL file (“view definition”), in a format that is easier to process. Because the metadata 113/115 represents the definitions, there is a mapping between the DDL file and the respective generated metadata. The generated metadata is stored in database tables of the model metadata repository 124 as content in the database tables, not as database objects. As described further below, the metadata may be transformed to database objects by the activation engine during an activation process. There may be multiple metadata tables for each definition, with one metadata table representing the source code, and the other metadata tables including additional information (e.g., annotations). In one or more embodiments, for every object type there is a source table that includes source code, while the fields and headers and annotations, etc. are in a different table. The metadata representing the source code in a structured format may be referred to herein as “stack code” or “stack format”. For example, the source code of the definition may be parsed to output the stack code, which then may be mapped to a metadata table. In other words, the textural/string code of the DDL file is used to generate the stack code, where the stack code represents the same structure as the code of the DDL file. While a stack code is generated for each aspect definition and view definition, the stack codes have different structures, as described further below with respect to FIG. 6.

The development server 104 further includes an activation engine 109. Activation, as used herein, may be with respect to each object (e.g., aspect, view, etc.) independently. The activation engine 109 is adapted to receive a request from a user 106 via the UI system 105 to “compile” or “activate” the metadata 113 for the aspect saved as content in the database tables of the model metadata repository 124. The activation engine 109 activates the aspect by transforming the aspect definition into aspect definition metadata. The activation engine 190 is further adapted to receive a request from a user 106 via the UI system 105 to “compile” or “activate” the view that binds an aspect. Activation of the view uses the metadata generated from activation of the aspect. The activation engine 109 generates, via the activation process for activation of the view, one SQL view and a corresponding runtime object for each view. Active versions of development objects, as well as corresponding runtime objects, are generated by the activation engine as part of the activation process after activating the view. One generated object may be the runtime object and another generated object may be a SQL view. The SQL View and runtime object may be saved as data 120 in a database 122 of the design environment 102. Subsequent to activation, the SQL view and runtime object may be accessed during execution of the application under development 116 to process data. In one or more embodiments, in a case the aspect is changed, the changed aspect is activated again (re-activated) and views that depend on that aspect are identified, and those identified views are re-activated as well.

The run-time environment 108 is a real-time setting that hosts, on the back-end server 110, the application software or product 118 that is made available as a live usable operation for the intended end users. The application under development 116 is no longer under development in the run-time environment 108 and is the application 118. Execution of the application 118 includes access to the database 122 per the SQL views included in the application 118, as well as execution of the SQL view that includes the fields from the aspect.

The application under development 116 created in the design-time environment 102 and the application 118 hosted by the run-time environment 108 may comprise program code executable by a processing unit to provide functions to end users (not shown) based on coded logic and on data 120 stored in data store 122. Each of the environments may also include data 120 stored in data stores 122 for use with the application 118, the application under development 116, and any other application used by the servers in the respective environments. Data 120 may comprise tabular data stored in a columnar or row-based format, object data or any other type of data that is or becomes known. Data store 122 may comprise any suitable storage system such as database system, which may be partially or fully remote from development server 104, and back-end server 110, and may be distributed as is known in the art.

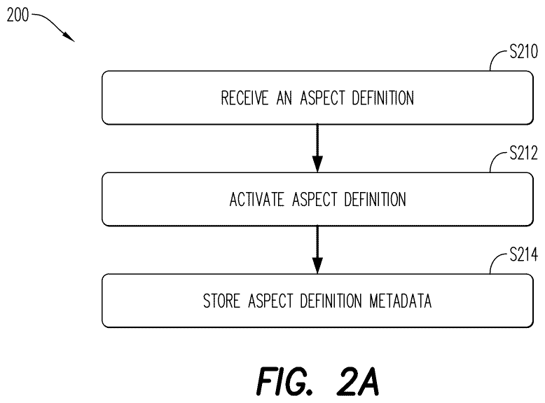

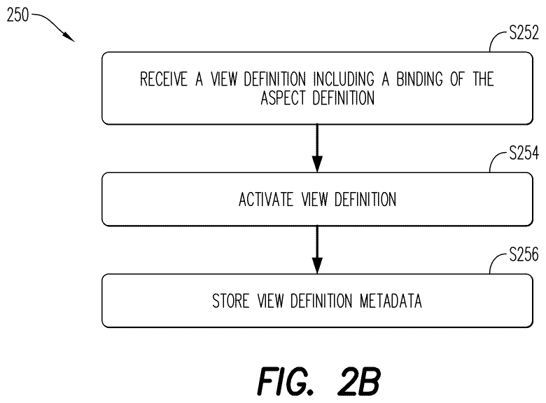

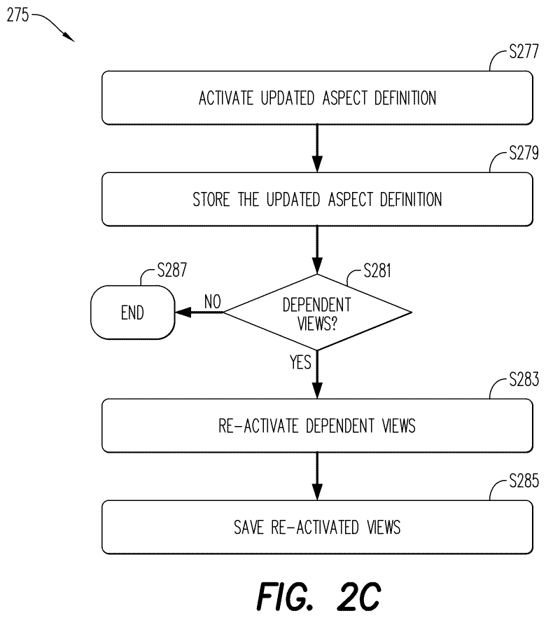

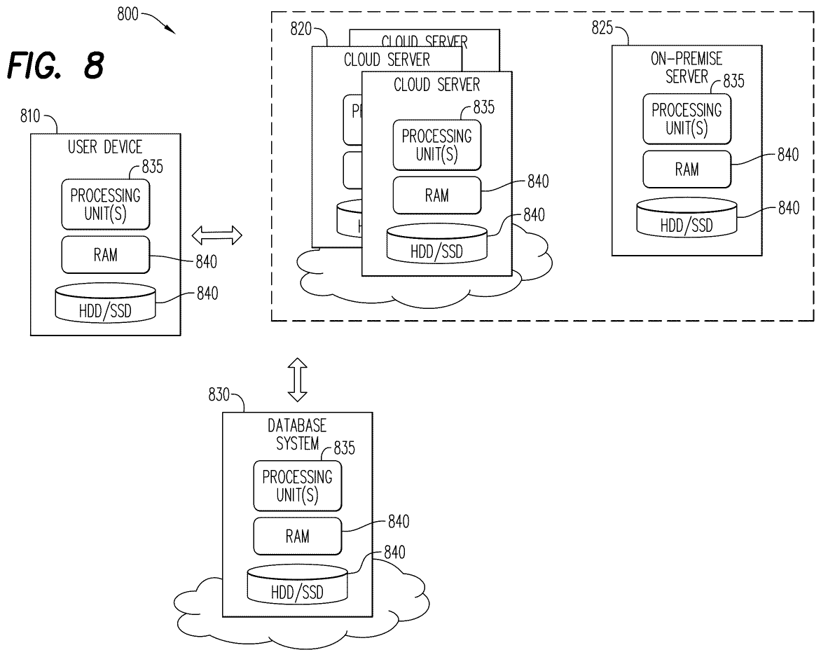

FIGS. 2A-2C illustrates processes 200, 250 and 275 according to some embodiments. The processes 200, 250 and 275 and other processes described herein, may be performed by a database node, a cloud platform, a server, a computing system (user device), a combination of devices/nodes, or the like, according to some embodiments. In one or more embodiments, the system architecture 100 may be conditioned to perform the processes 200, 250, 275, and other processes described herein, such that a processing unit 835 (FIG. 8) of the system architecture 100 is a special purpose element configured to perform operations not performable by a general-purpose computer or device.

All processes mentioned herein may be executed by various hardware elements and/or embodied in processor-executable program code read from one or more of non-transitory computer-readable media, such as a hard drive, a floppy disk, a CD-ROM, a DVD-ROM, a Flash drive, Flash memory, a magnetic tape, and solid state Random Access Memory (RAM) or Read Only Memory (ROM) storage units, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

In particular, FIG. 2A includes the process 200 for activating the aspect. Initially, at S210 an aspect 126 is generated via receipt of an aspect definition (FIG. 3). The aspect definition 302 is a snippet of code received in a DDL file (e.g., having a DDL datatype structure) at the DDL editor 107. As described above, DDL is a SQL DDL, which is a plain text file that contains commands used to describe the structure of a database, like its tables, records, columns and other fields. As a non-exhaustive example, FIG. 3 includes a user interface 300 of the DDL editor107. The aspect 126 may effectively be a small data model itself, that is concise to handle one or more specific calculations. The aspect definition 302 includes one or more fields 304, and a field type 306 or field implementation 310 for each of the fields.

In the non-exhaustive example shown herein, this aspect definition 302 includes fields 304: BaseAmount, BaseAmountCurrency, Discount and Tax. The BaseAmount field 304 includes a field type 306 of currency (i.e., abap.curr). The aspect definition 302 also includes an expression 308 that references the fields 304. Here, the expression 308 is a calculation.

As used herein, calculation may refer to any type of transformation of the data e.g., concatenation of text fields, mathematical operation, assigning a constant value to a field, a transformation that results in some value (e.g., numeric, string, etc.) being presented, etc. In particular, given the discount field 304 and the tax field 304, the aspect definition 302 includes an expression 308 to calculate the discounted amount as the base amount minus the base amount times the discount (i.e., DiscountedAmount=curr_to_decfloat_amount(BaseAmount)−(curr_to_decfloat_amount(Discount)) and an expression 308 to calculate a tax discounted amount (i.e., DiscountedAmountTaxed=DiscountedAmount*Tax). The aspect definition 302 also defines (shown herein in lines 8 and 10), that for each of these calculated amounts, a currency code is associated therewith.

Then in S212 the aspect definition 302 is activated via a metadata extraction element 111 of the DDL editor 107. Activation of the aspect definition 302 generates corresponding aspect definition metadata 113. The aspect definition metadata 113 is a different representation of the aspect definition 302 with respect to structure. As a first different representation, the single DDL file of the aspect definition is represented as multiple metadata tables including annotations.

Continuing with the non-exhaustive example in FIG. 3, for the DiscountedAmount, there is a currency code. This currency code is additional information (annotations) for the Discounted amount, and there is one metadata table that contains the fields (DiscountedAmount) and another metadata table that contains annotation information about the fields—in this case currency code (e.g., the DiscountedAmount field is annotated with the currency code). As a second different representation, the activation includes transforming the DDL format (i.e., textual code) to a stack data structure format. In particular, the source code metadata is in stack data structure format (“stack”) (as compared to the aspect definition that is in DDL). The stack data structure serves as a collection of elements with two main operations: “push”, which adds an element to the collection, and “pop”, which removes the most recently added element, such that the insertion and deletion of elements happens only at one endpoint. The stack format may be in a hierarchical form with a line for each field, and then each field may or may not have a child, which may or may not be an annotation (e.g., the child can be an additional key word, etc.), and the annotation may (or may not) have a child, etc.

The aspect definition metadata 115 is stored in the model metadata repository 124 in S214. The aspect definition metadata 115 is stored as content in the database tables (e.g., not stored as database objects).

The inventors note, pursuant to one or more embodiments, in a case an aspect field is bound against an existing view field, it is not included again into the CDS view; in a case an aspect field is bound against an underlying view field, it is included into the CDS view. Additionally, pursuant to one or more embodiments, there are a plurality of rules for implementing the CDS aspect. The rules include, but are not limited to: all fields of a CDS aspect without an implementation need to be bound inside the CDS view; CDS aspects can be included multiple times with different binding aliases; field names can be redefined by the CDS view by using the addition “alias” in order to specialize the use case; all CDS aspect fields may be included at once via an include mechanism with “include *”, or the fields may be included individually; any CDS aspect field may be prevented from being included in a list of all fields via an exclude mechanism that excludes all of the bound fields (e.g., include _ProductLengthDeviation.* excluding {$bound_elements}) that allows bringing only a subset of the CDS aspect fields or that excludes the fields individually; and field names may be redefined by the CDS view by using the addition “as” in order to specialize the use case. Other suitable rules may be included. Pursuant to embodiments, the development tool 103 may ensure the implementation rules are satisfied before the aspect definition 302 is activated as an aspect 126. In a case the aspect definition 302 does not satisfy one or more rules, a notification may be provided to the user indicating the rules are not satisfied. It is noted that other suitable checks may be performed before the aspect definition is activated and/or saved. It is further noted that, pursuant to some embodiments, the aspect definition may be saved in a case the rules are not satisfied.

FIG. 2B includes the process 250 for activating the view. Initially, at S252 a view 114 is generated via receipt of a view definition (FIG. 4), the view definition including at least a binding of the aspect definition and at least one view field. As described above, the view definition may include CDS aspects, annotations (e.g., providing additional information about the data, such as data types, field labels, and descriptions) and associations (e.g., to define relationships between entities in the data model).

Continuing with the non-exhaustive example, FIG. 4 is UI 400 showing the view definition 402. The view definition 402 is a snippet of code received in a DDL file (e.g., having a DDL datatype structure) at the DDL editor 107. The DDL editor 107 may receive the view definition 402 and save the definition as the view 114. Here, the view definition 402 includes references to one or more data sources from which it reads the data and/or targets on which the definition will be projected on top of.

In the non-exhaustive example shown herein, the text “as select from I_DD_TSM_SO as SalesOrder” indicates the data source table is I_DD_TSM_SO, which will be projected onto the SalesOrder entity. As other non-exhaustive examples, one view may show the individual sales orders, while another view groups them by sales area or country or city, still another view may be on top of these objects that aggregates them, etc.

The binding of the aspect definition to the view definition 402 is via the “bind aspect” syntax 404. Use of the “bind aspect” syntax 404 indicates a dependency in that the view will use the aspect's metadata to generate its own metadata. As described further below, due to this dependency, new activations of the aspect may also re-activate the view. Binding provides for the replication of the aspect into the database model/view. The binding gives the fields a value because without the binding, the fields only have a type definition. Here, the view definition 402 further indicates: the field “BaseAmount” corresponds to the amount_sum of the sales order per the Key, the currency is the currency_sum, etc. The “projection” syntax 406 indicates the fields that this view exposes (e.g., BaseAmoutCurrency, Discount and Tax). Here, both the discount and tax are declared as a literal (e.g., decfloat34) per the key. When activated, values are inserted into the literal fields. The use of “include” syntax 408 indicates that the result of this calculation will be included as part of the fields of the view.

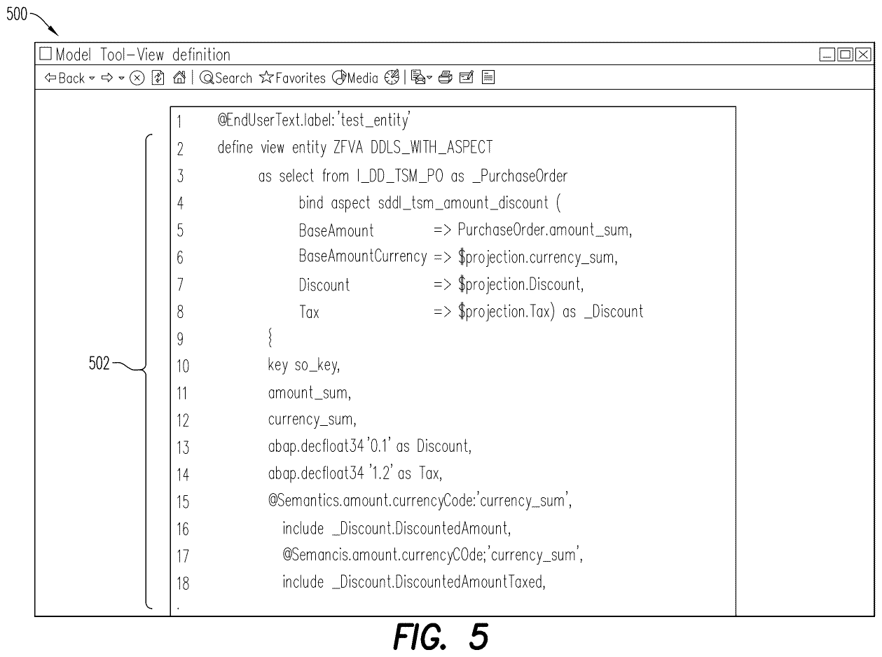

FIG. 5 is a UI 500 showing another view definition 502. In the view definition 502 of FIG. 5, the source table is not a sales order, but instead is a purchase order. It may also be desirable to calculate discounts for purchase orders. Pursuant to embodiments, the CDS aspect was defined once in FIG. 3 and may be used in multiple views. The “bind aspect” syntax used in FIG. 4, is also used in FIG. 5, as the calculation of each of the discount and the tax discount is the same in both the view definition 402 of FIG. 4 and the view definition 502 of FIG. 5. It is noted that the values for the discount and tax discount may be different in the calculations. For example, in the view definition 402 of FIG. 4, the discount is 0.05, and the tax discount is 1.19, while in the view definition 502 of FIG. 5, the discount is 0.1 and the tax discount is 1.2.

By including the aspect as its own definition, if there is a change made to the calculation, the change may be made in the aspect definition, and then the change is replicated in every view that includes the aspect.

In some embodiments, the CDS aspect may be used as a “Signature Include” command where the CDS aspect is used to define a set of elements that can be reused for type definitions only. In this “Signature Include” case, the CDS aspect has no calculated fields, and instead only describes a group of fields for use in a more complex data model.

Turning back to the process 250, at S254 the view definition 402 is activated via the metadata extraction element 111 of the DDL editor 107. Activation of the view definition generates the corresponding view definition metadata 115. The view definition metadata 115 is a different representation of the view definition 402 with respect to structure. As with the aspect definition and the aspect definition metadata, the single DDL file of the view definition is represented as multiple metadata tables including annotations. There is one metadata table that contains the fields and another metadata table that contains annotation information about the fields. The metadata tables including the fields may be referred to as source code metadata tables vs the metadata tables including the annotations. Also like the aspect definition and the aspect definition metadata, the generation of the view definition metadata includes transforming the DDL format (i.e., textual code) of the view definition to a stack data structure format. It is noted that while each of the aspect definition and view definitions are transformed into respective metadata, the metadata for each is different as the aspect definition has a different structure than the view definition.

The view definition metadata 115 is stored at S256.

FIG. 2C includes the process 275 for updating an aspect 126. In a case the aspect is changed and re-activated in the future and there are entities that depend on that aspect, those entities are also re-activated, as described by the process 275 of FIG. 2C. Prior to the process 275, the aspect was activated. Then updates were made to the aspect definition. As a non-exhaustive example of an update, the discounted amount formula changed. At S277 the updated aspect is activated, as described above in S212. A subsequent activation of an aspect may be referred to as a “re-activation”. Then, at S279, the re-activated aspect is stored. Next, in S281, it is determined whether any views depend on the re-activated aspect. The metadata for each view includes an indication of any aspects bound thereto. The dependency determination in S281 may be based on a look-up of the views which have bound the aspect currently being re-activated. In a case it is determined there are dependent views, the process 275 proceeds to S283 and the dependent views are activated (re-activated), as described above in S254. The re-activated views are saved at S285. In a case it is determined at S281 there are no dependent views, the process ends at S287.

FIG. 6 includes a block sequence chart 600 describing activation of the view including the bound aspect. For each identified view, activation of the view including the bound aspect includes first retrieving the view definition metadata 115 from the model metadata repository in 602 and then identifying the “bind aspect” syntax 404 included in the view at 604. Once the “bind aspect” syntax is identified, the aspect definition metadata 113 is retrieved from the model metadata repository 124 in 606. The structural (stack) format of the view is defined as a structured representation of the textual source code of the view. As described above, the stack format for the view is different from the stack format for the aspect. For incorporation of the aspect into the view, the fields defined in the aspect definition metadata 113, and associated metadata for those fields, are included with the fields defined by the annotations in the view definition metadata 115 that are required for execution of the expression (e.g., calculation). For the incorporation, and pursuant to some embodiments, the fields and type of information being used by the aspect definition metadata are extracted therefrom in 608, and then the extracted fields and associated metadata are replicated in the stack metadata of the view definition metadata in 610. After the incorporation, the stack metadata view includes fields from the aspect and fields from the view. After the incorporation, the aspect definition metadata is accessible via the structure of the view definition metadata.

After the transformed aspect definition metadata is added to the stacked metadata of the view, the updated view is saved as content in the model metadata repository 124. The activation engine 109 then generates, via the activation process for the view, one SQL view and a corresponding runtime object for each view for storage in the database 122. Active versions of development objects, as well as corresponding runtime objects, are generated by the activation engine as part of the activation process after activating the view. The runtime object and the SQL view (e.g., a development object) for the runtime object may be generated together. The SQL View and runtime object may be saved as data 120 in a database 122 of the design environment 102. Subsequent to activation, the SQL view and runtime object may be accessed during execution of the application under development 116 to process data.

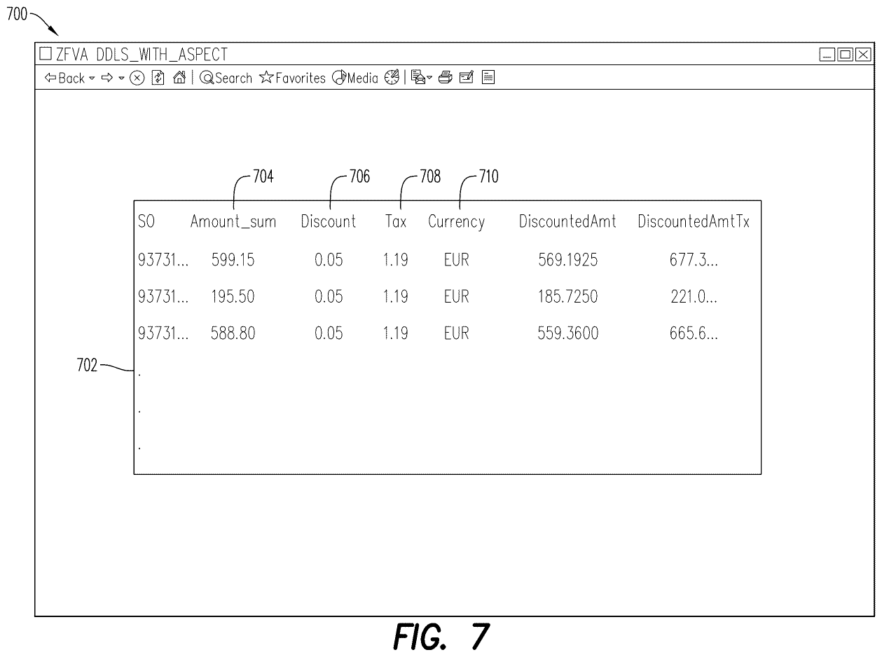

FIG. 7 is a UI display 700 including data 702 output from execution of the aspect bound view as part of execution of the application under development 116 or the application 118. In particular, this is the data from the database table (SalesOrder) with the aspect applied thereto. The database table has a view on top of it—in this case I_DD_TSM_SO, and then on top of this view is the ZFVA_DDLS_WITH_ASPECT view. Here, the Amount field 704 is populated from the database, the Discount 706 and Tax 708 are declared in the view definition as constants, making them the same for each entry. The currency 710 is coming from the aspect, with the value (EUR) coming from the binding, and in particular the value is from the currency sum table field in the SalesOrder table per the BaseAmountCurrency field in the aspect definition 302. With respect to the discounted amount, the calculation is declared in the aspect definition 302, and then included in the view definition 402 via the “include” keyword 408 (FIG. 4). The system then performs this calculation when it reads this line of code during execution of the application.

FIG. 8 illustrates a cloud-based database deployment 800 according to some embodiments. The illustrated components may reside in one or more public clouds providing self-service and immediate provisioning, autoscaling, security, compliance and identity management features.

User device 810 may interact with applications executing on one of the cloud server 820 or the on-premise server 825, for example via a Web Browser executing on user device 810, in order to generate an aspect, a view and an aspect bound view for data managed by a database system 830. Database system 830 may store data as described herein and may execute processes as described herein to cause the creation and execution of the aspect. Cloud server 820 and database system 830 may comprise cloud-based compute resources, such as virtual machines, allocated by a public cloud provider. As such, cloud server 820 and database system 130 may be subjected to demand-based resource elasticity. Each of the user device 810, cloud server 820, and on-premise server 825 and database system 830 may include a processing unit 835 that may include one or more processing devices each including one or more processing cores. In some examples, the processing unit 835 is a multicore processor or a plurality of multicore processors. Also, the processing unit 835 may be fixed or it may be reconfigurable. The processing unit 835 may control the components of any of the user device 810, cloud server 820, on-premise application server 825, and database system 830. The storage devices 840 may not be limited to a particular storage device and may include any known memory device such as RAM, ROM, hard disk, and the like, and may or may not be included within a database system, a cloud environment, a web server or the like. The storage device 840 may store software modules or other instructions/executable code which can be executed by the processing unit 835 to perform the method shown in FIG. 2. According to various embodiments, the storage device 840 may include a data store having a plurality of tables, records, partitions and sub-partitions. The storage device 840 may be used to store database records, documents, entries, and the like.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, external drive, semiconductor memory such as read-only memory (ROM), random-access memory (RAM), and/or any other non-transitory transmitting and/or receiving medium such as the Internet, cloud storage, the Internet of Things (IoT), or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A system comprising:
a memory storing program code; and
one or more processing units to execute the program code to cause the system to:
receive an aspect definition in a first format, the aspect definition including at least one aspect field;
activate the aspect definition, activation of the aspect definition generates aspect definition metadata, the aspect definition metadata is in a second format;
store the aspect definition metadata;
receive a view definition including a binding of the aspect definition and at least one view field; and
activate the view definition, activation of the view definition generates view definition metadata, the view definition metadata is in the second format, wherein activation of the view definition incorporates the aspect definition metadata into the view definition metadata.

2. The system of claim 1, wherein the first format is a data definition language (DDL).

3. The system of claim 1, wherein the second format is a stack format.

4. The system of claim 3, wherein the aspect definition metadata is a first stack code arranged in an aspect stack format, and the view definition metadata is a second stack code arranged in a view stack format.

5. The system of claim 1, wherein activation of the view definition includes extracting metadata for at least one field and the field from the aspect definition metadata, and replicating the extracted metadata and the field in the view definition metadata.

6. The system of claim 1, further comprising program code to cause the system to:
receive an updated aspect definition;
activate the updated aspect definition, wherein activation of the updated aspect definition generates an updated aspect definition metadata;
determine a first view is dependent on the aspect definition metadata; and
re-activate the view definition into an updated view definition metadata using the updated aspect definition metadata.

7. The system of claim 6, wherein the first view is determined to be dependent based on a look-up of the views which have bound the aspect prior to the received updated aspect definition.

8. The system of claim 1, wherein the aspect definition defines a reusable expression.

9. The system of claim 1, further comprising program code to cause the system to:
receive a second view definition including a binding of the aspect definition and at least one second view field;
and
activate the second view definition, activation including generation of second view definition metadata, the second view definition metadata is in the second format, wherein activation of the second view definition incorporates the aspect definition metadata into the second view definition metadata.

10. A computer-implemented method comprising:
receiving an aspect definition in a Data Definition Language (DDL) format, the aspect definition including at least one aspect field;
activating the aspect definition, activation of the aspect definition generates aspect definition metadata, the aspect definition metadata is in a stack format;
storing the aspect definition metadata;
receiving a view definition including a binding of the aspect definition and at least one view field; and
activating the view definition, activation of the view definition including generating view definition metadata, the view definition metadata is in the stack format, wherein activation of the view definition incorporates the aspect definition metadata into the view definition metadata.

11. The method of claim 10, further comprising:
receiving a second view definition including a binding of the aspect definition and at least one second view field;
and
activating the second view definition, activation including generating second view definition metadata, the second view definition metadata is in the stack format, wherein activation of the second view definition incorporates the aspect definition metadata into the second view definition metadata.

12. The method of claim 10, wherein the aspect definition metadata is a first stack code arranged in an aspect stack format, and the view definition metadata is a second stack code arranged in a view stack format.

13. The method of claim 10, wherein activation of the view definition further comprises:
extracting metadata for at least one field and the field from the aspect definition; and
replicating the extracted metadata and the field in the view definition metadata.

14. The method of claim 10, further comprising:
receiving an updated aspect definition;
activating the updated aspect definition, wherein the activation of the updated aspect definition generates an updated aspect definition metadata;
determining a first view is dependent on the aspect definition metadata; and
re-activating the view definition into an updated view definition metadata using the updated aspect definition metadata.

15. The method of claim 14, wherein the first view is determined to be dependent based on a look-up of the views which have bound the aspect prior to the received updated aspect definition.

16. One or more non-transitory, computer-readable medium storing instructions, that, when executed by a computing system, cause the computing system to perform operations comprising:
receiving an aspect definition in a Data Definition Language (DDL), the aspect definition including at least one aspect field;
activating the aspect definition, activation of the aspect definition generates aspect definition metadata, the aspect definition metadata is in a stack format;
storing the aspect definition metadata;
receiving a view definition including a binding of the aspect definition and at least one view field; and
activating the view definition, activation of the view definition including generating view definition metadata, the view definition metadata is in the stack format, wherein activation of the view definition incorporates the aspect definition metadata into the view definition metadata.

17. The medium of claim 16, further comprising:
receiving a second view definition including a binding of the aspect definition and at least one second view field;
and
activating the second view definition, activation including generation of a second view definition metadata, the second view definition metadata is in the stack format, wherein activation of the second view definition incorporates the aspect definition metadata into the second view definition metadata.

18. The medium of claim 16, wherein the aspect definition metadata is a first stack code arranged in an aspect stack format, and the view definition metadata is a second stack code arranged in a view stack format.

19. The medium of claim 16, further comprising:
receiving an updated aspect definition;
activating the updated aspect definition, wherein activation of the updated aspect definition generates an updated aspect definition metadata;
determining a first view is dependent on the aspect definition metadata; and
re-activating the view definition into an updated view definition metadata using the updated aspect definition metadata.

20. The medium of claim 19, wherein activation of the view definition further comprises:
extracting metadata for at least one field and the field from the aspect definition; and
replicating the extracted metadata and the field in the view definition metadata.
